(19) United States
(12) Patent Application Publication
(10) Pub. No.: US 2026/0203529 A1
(43) Pub. Date: Jul. 16, 2026

(54) METHOD FOR PROVIDING CONTENT ACCORDING TO USER INTENT, AND ELECTRONIC DEVICE THEREFOR

(71) Applicant: Samsung Electronics Co., Ltd., Suwon-si (KR)

(72) Inventors: Eunkyung LEE, Suwon-si (KR); Kyoungtaek KIM, Suwon-si (KR); Semin PARK, Suwon-si (KR); Jinwoo PARK, Suwon-si (KR); Hyungjin PARK, Suwon-si (KR); Seoyoung SON, Suwon-si (KR); Dayoung CHUNG, Suwon-si (KR); Dohee CHUNG, Suwon-si (KR)

(21) Appl. No.: 19/562,011

(22) Filed: Mar. 10, 2026

Related U.S. Application Data
(63) Continuation of application No. PCT/KR2024/013422, filed on Sep. 5, 2024.

(30) Foreign Application Priority Data
Sep. 15, 2023 (KR) 10-2023-0123287
Apr. 4, 2024 (KR) 10-2024-0046036

(51) Int. Cl. G06F 40/40; G06F 40/10

(52) U.S. Cl. CPC G06F 40/40; G06F 40/10

(57) ABSTRACT

An electronic device is provided. The electronic device includes a display; memory, including one or more storage media, storing instructions, and one or more processors communicatively coupled to the display and the memory, wherein the instructions, when executed by the one or more processors individually or collectively, cause the electronic device to receive a user query from a user via an assistant application, after receiving the user query, determine whether a maximum response length limiting an amount of content to be included in a response to the user query exists, in case that the maximum response length exists, transfer the maximum response length and the user query to an artificial intelligence (AI) engine, in case the maximum response length does not exist, transfer only the user query to the AI engine, and provide a response obtained from the AI engine.

### CROSS-REFERENCE TO RELATED APPLICATION(S)

This application is a continuation application, claiming priority under 35 U.S.C. § 365(c), of an International application No. PCT/KR2024/013422, filed on Sep. 5, 2024, which is based on and claims the benefit of a Korean patent application number 10-2023-0123287, filed on Sep. 15, 2023, in the Ministry of Intellectual Property (MOIP), and of a Korean patent application number 10-2024-0046036, filed on Apr. 4, 2024, in the Ministry of Intellectual Property (MOIP), the disclosure of each of which is incorporated by reference herein in its entirety.

### BACKGROUND

### 1. Field

The disclosure relates to a method of providing content according to a user's intention and an electronic device therefor.

### 2. Description of Related Art

With the development of digital technologies, various types of electronic devices have been widely utilized, such as mobile communication terminals, personal digital assistants (PDA), electronic organizers, smartphones, tablet personal computers (PC), wearable devices, and the like. Hardware parts and/or software parts of the electronic devices have been continuously improved in order to support and increase the functions of the electronic devices.

Recently, large language models (LLMs) have been making progress in technologies for understanding languages, as well as summarizing long sentences and compressing their content. The electronic device obtains result data (e.g., response to query) with regard to a user query via an LLM server, and provides the obtained result data to a user. However, since the result data may include a large amount of information, the user may need to search for desired information from the result data.

The above information is presented as background information only to assist with an understanding of the disclosure. no determination has been made, and no assertion is made, as to whether any of the above might be applicable as prior art with regard to the disclosure.

### SUMMARY

According to an embodiment, there may be provided a method and apparatus for identifying whether a maximum response length exists upon receiving a user query, generating, based on the maximum response length, a response corresponding to the user query when the maximum response length exists, generating a response corresponding to the user query, irrespective of the maximum response length when no maximum response length exists, and providing the same to a user.

Aspects of the disclosure are to address at least the above-mentioned problems and/or disadvantages and to provide at least the advantages described below. Accordingly, an aspect of the disclosure is to provide a method of providing content according to a user's intention and an electronic device therefor.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, including one or more storage media, storing instructions; and one or more processors communicatively coupled to the display and the memory, wherein the instructions, when executed by the one or more processors individually or collectively, cause the electronic device to receive a user query from a user via an assistant application, after receiving the user query, determine whether a maximum response length limiting an amount of content to be included in a response to the user query exists, in case that the maximum response length exists, transfer the maximum response length and the user query to an artificial intelligence (AI) engine, in case the maximum response length does not exist, transfer only the user query to the AI engine, and provide a response obtained from the AI engine.

In accordance with another aspect of the disclosure, an electronic device is provided. The electronic device includes the display, the processor, and the memory, and the instructions stored in the memory, when executed by the processor, cause the electronic device to successively display a response corresponding to a user query via the assistant application, detect a user input requesting to stop the response, while providing the response, collect, based on the user input, a length of the response displayed on the display, determine a maximum response length of a response by learning the collected length, and store the determined maximum response length in the memory.

In accordance with another aspect of the disclosure, a method performed by an electronic device is provided. The method includes receiving, by the electronic device, a user query from a user via an assistant application, after receiving the user query, determining, by the electronic device, whether a maximum response length limiting an amount of content to be included in a response to the user query exists, in case that the maximum response length exists, transferring, by the electronic device, the maximum response length and the user query to an artificial intelligence (AI) engine, in case that the maximum response length does not exist, transferring, by the electronic device, only the user query to the AI engine, and providing, by the electronic device, a response obtained from the AI engine.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, by the electronic device, a user query from a user via an assistant application, after receiving the user query, determining, by the electronic device, whether a maximum response length limiting an amount of content to be included in a response to the user query exists, in case that the maximum response length exists, transferring, by the electronic device, the maximum response length and the user query to an artificial intelligence (AI) engine, in case that the maximum response length does not exist, transferring, by the electronic device, only the user query to the AI engine, and providing, by the electronic device, a response obtained from the AI engine.

According to an embodiment, when providing a response to a user query via an assistant application, a response with a volume (e.g., length, size, or amount) desired by a user is generated.

According to an embodiment, since a desired response length differs for each user, a response that matches the user's intention is provided by determining the length of a response based on the user's usage pattern.

According to an embodiment, user convenience is improved by providing a user interface capable of adjusting a length of a response in consideration of a user's usage pattern after the length of a response is determined.

According to an embodiment, user convenience is improved by configuring or releasing a length of a response based on a user's usage pattern.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of a generative artificial intelligence system according to an embodiment of the disclosure;

FIG. 3 is a diagram illustrating an example in which a response length is changed based on the volume of a response in an electronic device according to an embodiment of the disclosure;

FIG. 4 is a flowchart illustrating an operation method of an electronic device according to an embodiment of the disclosure;

FIG. 5A is a diagram illustrating an example of generating a response based on a maximum response length in an electronic device according to an embodiment of the disclosure;

FIG. 5B is a diagram illustrating an example of providing a detailed view of a response in an electronic device according to an embodiment of the disclosure;

FIG. 6 is a flowchart illustrating a method of collecting a length of a response in an electronic device according to an embodiment of the disclosure;

FIGS. 7A and 7B are diagrams illustrating an example of determining a maximum response length based on a type of content in an electronic device according to various embodiments of the disclosure;

FIG. 8 is a diagram illustrating an example of collecting a length of a response in an electronic device according to an embodiment of the disclosure;

FIGS. 9A and 9B are diagrams illustrating an example of providing a detailed response in response to a user request in an electronic device according to various embodiments of the disclosure;

FIG. 10 is a diagram illustrating an example of configuring a maximum response length according to a domain in an electronic device according to an embodiment of the disclosure;

FIG. 11 is a flowchart illustrating a method for configuring a maximum response length in an electronic device according to an embodiment of the disclosure;

FIG. 12 is a diagram illustrating an example of releasing a maximum response length in an electronic device according to an embodiment of the disclosure; and

FIG. 13 is a diagram illustrating an example of configuring a maximum response length in an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

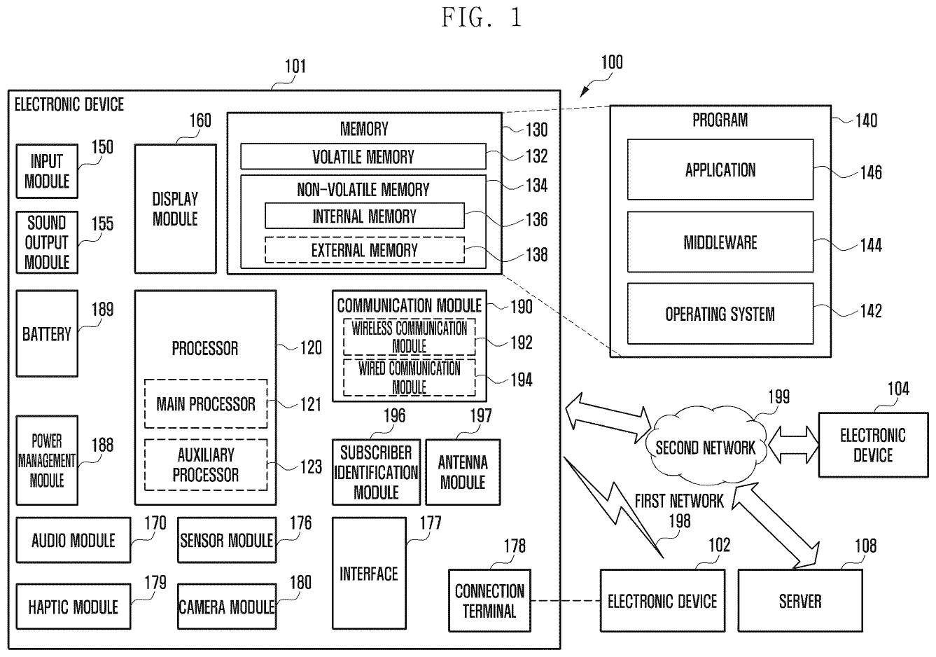

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134, and the non-volatile memory 134 may include internal memory 136 and external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

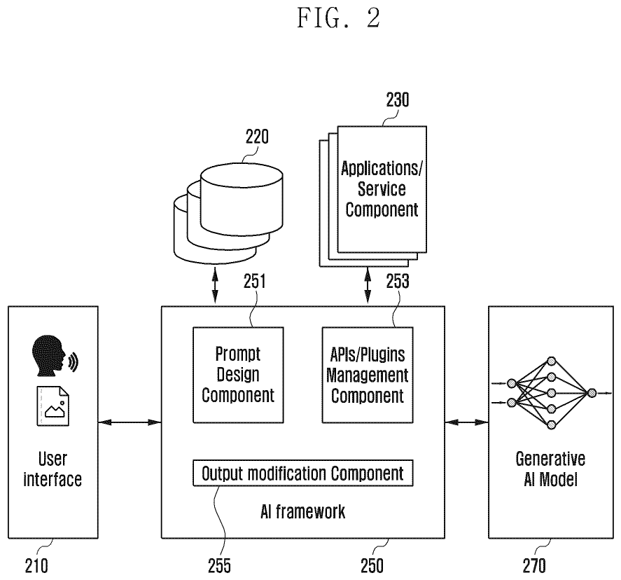

FIG. 2 is a block diagram illustrating an example of a generative artificial intelligence system according to an embodiment of the disclosure.

Referring to FIG. 2, a generative artificial intelligence system (e.g., an intelligent server or the server 108 in FIG. 1) according to an embodiment may include a user interface 210, a database 220, application and service components 230, an AI framework 250, and a generative AI model 270.

The user interface 210 may receive an input of a user query. The user query may have the form of natural language, images, and videos. In addition, when the user makes a query, context information may be transmitted together. As another example, the user query can be an unnatural input that does not generate natural language such as a design request or a modification. In addition, a mixed form of the above-described natural language, image, sound, and context information is also possible. Moreover, the user interface 210 may output the result of the generative artificial intelligence system to the user. The output may be in the form of natural language or a specific content, and may also be provided in the form of an action requested by the user.

The AI framework 250 may receive an input of the user query, and coordinate and control each component necessary to perform the user's intention. The AI framework 250 may include a prompt design component 251, an application and plugin (APIs/plugins) management component 253, and an output modification component 255.

The user query or action input through the user interface 210 may be transmitted to the prompt design component 251. The prompt design component 251 may be used to generate a prompt suitable for the input into a large language model (LLM) or large multimodal models. The prompt design component 251 may be an AI component that uses machine learning algorithms or neural networks to develop better prompts as time passes. The prompt design component 251 may access a knowledge component including user preference data, a prompt library, and prompt examples to generate a prompt and transfer the same to a large language model (LLM) or a large multi-modal model (LMM).

The application and plugin management component 253 may serve to perform communicating with external information if there is a request for additional information when a user input is transferred as the input of the generative model. The application and plugin management component 253 may construct a channel capable of communicating with the outside of the AI interface through an application programming interface (API), thereby allowing access to various data sources. In addition, when an action for performing the user query rather than the intermediate result should be finally performed by an application or a service, the application and plugin management component 253 may make a request for the corresponding action through an API. The information secured from the outside may be transferred as the input of the generative model together with the user input.

The output modification component 255 may finely tune the result output from the generative model. For example, the output modification component 255 may verify whether the content generated through a language model (LLM) or a large-scale multimodal model (LMM) is irrelevant, includes biased content, or includes harmful content. In addition, the output modification component 255 may determine to which extent the output conforms to a desired result of the user, and if an additional process is needed, perform the corresponding process. Additionally, the output modification component 255 may configure a hint for avoiding an unintended output and provide the same to the user.

The generative AI model 270 generally refers to an artificial intelligence neural network that makes new types of data, depending on user input information. Typical models for generating images include a generative adversarial network (GAN) and a variational auto encoder (VAE), and recently, a diffusion-based generative model using a VAE and a Transformer structure is referred to as a generative model. In addition, the language model is a model trained to output the most appropriate output value statistically based on the input value, and examples thereof representatively include models such as CHAT-GPT 3 and CHAT-GPT 4. Moreover, the model may recognize various types of data inputs, such as text, images, and sounds, and generate new data in response thereto, and thus is called a large multimodal model (LMM).

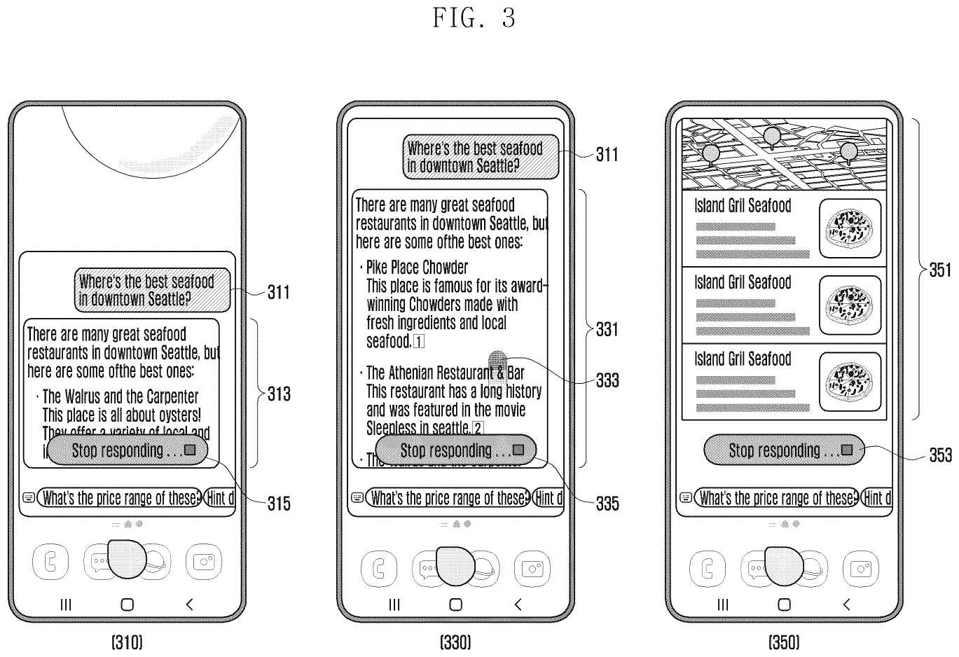

FIG. 3 is a diagram illustrating an example in which a response length is changed based on the volume of a response in an electronic device according to an embodiment of the disclosure.

Referring to FIG. 3, a processor (e.g., processor 120 in FIG. 1) of an electronic device (e.g., electronic device 101 in FIG. 1) according to an embodiment may receive a user query 311 via an assistant application (e.g., application 146 in FIG. 1), and display a first user interface 310 on a display (e.g., display module 160 in FIG. 1). The assistant application may include a voice assistant and an AI assistant. Although it is written as a “voice assistant,” various other inputs (e.g., text input via a keypad, writing input via a pen, and gesture input) are allowed in addition to voice. The assistant application (or voice assistant service) may collect and provide customized information for a user based on an artificial intelligence (AI) engine and voice recognition, and perform, based on the user's voice commands, various tasks such as schedule management, e-mail transmission, and restaurant reservation. For example, in order to call the voice assistant, the user may utter a predetermined voice call word (e.g., Hi Bixby), select a display object (e.g., icon) of the assistant application, or press a button related to the assistant.

The processor 120 may execute the assistant application upon detecting a voice call word obtained via a microphone (e.g., input module 150 in FIG. 1). Alternatively, the processor 120 may execute the voice assistant application when a button (e.g., software button or physical button) associated with the assistant is selected. When the button is selected, the processor 120 may display a keypad on an execution screen of the executed voice assistant application. When the voice assistant is called by voice, the voice assistant may operate based on voice, and when the voice assistant is called by a button, the voice assistant may operate based on text (keyboard displayed), but this is not limited thereto.

The first user interface 310 may include a first response 313 corresponding to a user query 311 and a response stop object 315. The user query 311 may be a voice command (e.g., user utterance) obtained via the microphone, or may be text obtained via a writing input via a pen or a keypad displayed on an execution screen of the executed assistant application. When a voice command is received as the user query 311, the processor 120 may display text regarding the user query 311, based on a speech to text (STT) function of converting the voice command to text. The processor 120 may generate a response based on the user query 311. The processor 120 may generate a response corresponding to the user query 311 by using an artificial intelligence (AI) engine. Alternatively, the processor 120 may transmit the user query 311 to an intelligent server (e.g., server 108 in FIG. 1 or generative AI system in FIG. 2) via a communication module (e.g., communication module 190 in FIG. 1), and may receive a response from the server 108. The first response 313 may be output via a speaker (e.g., sound output module 155 in FIG. 1) based on a text to speech (TTS) function or may be displayed on the display module 160. The first response 313 may include at least one of text, an image, audio, or video.

The size of a window (or area or bubble) for providing (or displaying) the first response 313 may be variably changed (e.g., increased (or expanded, extended) or reduced) based on the size (or length or amount) of the first response. The processor 120 may receive a response from the AI engine and sequentially display the response as it is received (e.g., by increasing the window size of the response), or may receive a response all at once from the AI engine and display the response on the screen only in sequence. The processor 120 may provide the first response 313 while generating (or receiving) a response, or may provide the first response 313 after completing the response generation (or reception). The response stop object 315 (or response stop indicator or response stop button) may be for requesting to stop responding. The processor 120 may display a response all at once after the whole response is received from the AI engine, but in doing so, a delay may occur before the display is shown on the screen, and thus the processor 120 may display the response in sequence while receiving the response from the AI engine. The processor 120 may receive a response all at once from the AI engine and display the same on the screen only in sequence. The stop of responding may include an operation of stopping displaying of a response after the response is displayed in sequence on the screen, or an operation of stopping reception of a response from the AI engine (or server). Since displaying the response that is displayed in sequence is stop, the window size for displaying the response may not be changed.

The processor 120 may display the response stop object 315, if there is more content to be provided as a response to the user query 311, in addition to the first response 313. When the response stop object 315 is selected, the processor 120 may stop generating a response or stop receiving a response from the server 108. The user may scroll the first response 313 and read down the first response 313, and then press the response stop object 315 to request to stop the first response 313 when the first response 313 is too long or is not a desired response.

A user input for requesting to stop responding may include a touch input, a pen input, or a voice command (e.g., user utterance). For example, the processor 120 may receive a touch input (or pen input) of touching the response stop object 315 displayed on the display module 160 as a user input requesting to stop responding. Alternatively, the processor 120 may receive a user utterance such as “stop responding,” “enough,” or “okay” as a user input requesting to discontinue the response. After the response stop object 315 is selected, if the response stop object 315 is reselected, the processor 120 may continue to provide a response following the first response 313. When the entire size of the first response 313 to be displayed via a window is larger than the size of the window, the processor 120 may increase the size of the window and continue to provide the first response 313. For the size of the response (or the entire size of the first response), the size of a response to be displayed in the window may be determined (e.g., font 8/200 characters, font 10/150 characters) in consideration of the amount of text, the type of language, font size, and image size (e.g., horizontal * vertical).

According to an embodiment, when a user input for not displaying an execution screen of the assistant application on the display module 160 is detected, the processor 120 may perform substantially the same operation as an operation performed when the response stop object 315 is selected. For example, the user input for not displaying the execution screen of the assistant application on the display module 160 may include a user input related to switching the execution screen of the assistant application to a home screen (e.g., selecting a home key), turning off the display module 160 (or power saving mode) (e.g., selecting a power key or lock key), or terminating (or canceling) the execution of the assistant application.

While providing the first user interface 310, when the window size of the first response 313 is increased, a second user interface 330 may be provided (or displayed). The second user interface 330 may include a second response 331 corresponding to the user query 311 and a response stop object 335. The first response 313 is a state in which only a portion of a response to a user query is displayed, and the second response 331 may be a state in which a response subsequent to the first response 313 is sequentially displayed and the volume of the response is increased. The response may be received all at once from the server 108 or may be received sequentially from the beginning of the response. The first response 313 and the second response 331 are distinguished as “first” and “second” for the purpose of understanding the disclosure since the lengths of the responses are different, and the disclosure is not limited thereto. When content to be provided based on the user query 311 remains in addition to the second response 331, the processor 120 may display a response stop object 335. When the user does not need a response other than the second response 331, the user may select the response stop object 335.

The processor 120 may detect a user input 333 for scrolling a screen while providing the second user interface 330. In response to detection of the user input 333, the processor 120 may display a third user interface 350 on the display module 160. The third user interface 350 may include a third response 351 and a response stop object 353. The third response 351 may be a state in which a response subsequent to the second response 331 is sequentially displayed, the volume of the response is increased. The response may be received all at once from the server 108 or may be received sequentially from the beginning of the response. By scrolling the second response 331, the processor 120 may display the response that continues below the second response 331. When content to be provided based on the user query 311 remains in addition to the third response 351, the processor 120 may display the response stop object 353. When the user does not need a response other than the third response 351, the user may select the response stop object 353. After the response stop object 353 is selected, if the response stop object 353 is reselected, the processor 120 may continue to provide a response after the third response 351.

The electronic device 101 according to an embodiment of the disclosure may include the display 160, the processor 120, and the memory 130, and, when executed by the processor, instructions stored in the memory may cause the electronic device to receive a user query from a user via an assistant application, to determine whether a maximum response length for limiting the amount of content to be included in a response to the user query exists after receiving the user query, to transfer the maximum response length and the user query to an artificial intelligence (AI) engine when the maximum response length exists, to transfer only the user query to the AI engine when no maximum response length exists, and to provide a response obtained from the AI engine.

The instructions, when executed by the processor, may cause the electronic device to detect a user input requesting a detailed view of the response while displaying the response generated based on the maximum response length and the user query, to request, from the AI engine, a response corresponding to the user query irrespective of the maximum response length, based on the user input, and to provide a response obtained from the AI engine.

The instructions, when executed by the processor, may cause the electronic device to obtain, from the AI engine, a first response corresponding to the maximum response length and the user query and a second response corresponding to the user query and irrelevant to the maximum response length, to provide the first response, and to provide the second response in response to a user request.

The instructions, when executed by the processor, may cause the electronic device to obtain, from the AI engine, a response corresponding to the user query irrespective of the maximum response length, to summarize the obtained response so as to correspond to the maximum response length, and to provide the summarized response.

The instructions, when executed by the processor, may cause the electronic device to obtain, from the AI engine, a response corresponding to the user query irrespective of the maximum response length, and to provide a portion of the obtained response, which corresponds to the maximum response length.

The instructions, when executed by the processor, may cause the electronic device to identify a domain associated with the user query, to identify a maximum response length configured for the identified domain, and to transfer the maximum response length and the user query to the AI engine.

The instructions, when executed by the processor, may cause the electronic device to release a configuration of the maximum response length configured for the domain when the number of requests for a detailed view of a response is greater than or equal to a threshold while providing the response corresponding to the domain.

The instructions, when executed by the processor, may cause the electronic device to detect a user input requesting to stop the response while displaying the response in sequence, and to collect, based on the user input, a length of the response displayed on the display.

The instructions, when executed by the processor, may cause the electronic device to not collect a length of the response when a new user query obtained after requesting to stop the response is not associated with the stop of the response.

The instructions, when executed by the processor, may cause the electronic device to determine the maximum response length based on at least one of a domain, time information, or location information, respectively.

The electronic device 101 according to an embodiment of the disclosure may include the display 160, the processor 120, and the memory 130, and, when executed by the processor, instructions stored in the memory may cause the electronic device to display, via the assistant application, a response corresponding to a user query in sequence, to detect a user input requesting to stop the response, while providing the response, to collect, based on the user input, a length of the response displayed on the display, to determine a maximum response length of a response by learning the collected length, and to store the determined maximum response length in the memory.

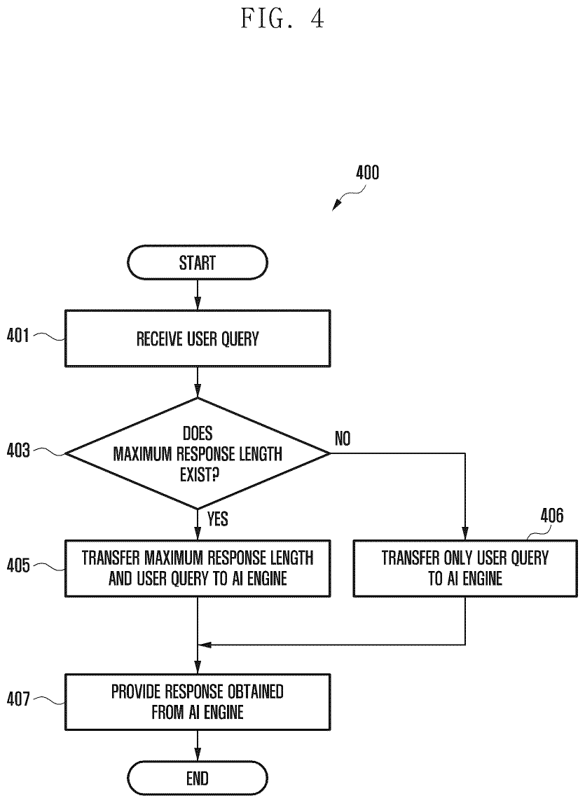

FIG. 4 is a flowchart 400 illustrating an operation method of an electronic device according to an embodiment of the disclosure.

In the following embodiments, operations may be performed in sequence, but are not necessarily performed in sequence. For example, the order of the operations may be changed, and at least two operations may be performed in parallel.

Referring to FIG. 4, in operation 401, a processor (e.g., processor 120 of FIG. 1) of an electronic device according to an embodiment (e.g., electronic device 101 of FIG. 1) may receive a user query. The user query may be a voice command (e.g., user utterance) obtained via a microphone (e.g., input module 155 in FIG. 1) or may be text obtained via a writing input via a pen or a keypad displayed on an execution screen of an assistant application. The processor 120 may receive the user query via the assistant application. The assistant application may include a voice assistant and an AI assistant. Although it is written as a “voice assistant,” various other inputs (e.g., text input via a keypad, writing input via a pen, and gesture input) are allowed in addition to voice. The assistant application (or voice assistant service) may collect and provide customized information for a user based on an artificial intelligence (AI) engine and voice recognition, and perform, based on the user's voice commands, various tasks such as schedule management, e-mail transmission, and restaurant reservation.

For example, in order to call the voice assistant, the user may utter a predetermined voice call word (e.g., Hi Bixby) or may press a button related to the assistant. In response to detecting the voice call word obtained via the input module 150, the processor 120 may execute the assistant application. Alternatively, the processor 120 may execute the assistant application when a button (e.g., software button or physical button) related to the assistant is selected. The processor 120 may display, on a display (e.g., display module 160 in FIG. 1), an execution screen of the assistant application including the user query.

In operation 403, according to an embodiment, the processor 120 may identify whether a maximum response length exists. After receiving the user query, the processor 120 may determine whether the maximum response length exists. The maximum response length may limit the amount (or size or length) of content to be included in a response to the user query after receiving the user query. The response provided via the AI engine may include a large amount of data, and some users may not want to see a response with too much data. Some users may check only the beginning of the response, ask another question (e.g., next user query), or not read the entire content of the response. The processor 120 may collect the user's usage pattern of using the assistant application during a designated period of time (e.g., one week, one month, two months), and analyze the collected usage pattern to configure (or determine) a maximum response length.

For example, the usage pattern may be the length of a response provided via the assistant application. When the user makes a request to stop displaying (e.g., selecting a response stop object) while the response is being displayed on a screen, the processor 120 may determine a maximum response length based on the length (e.g., number of characters) of the response displayed on the screen. When the total length of the response is 300 characters, and the user presses the response stop object in the state in which 100 characters are displayed on the screen, 100 characters may be recognized as the number of characters preferred by the user. The processor 120 may configure the maximum response length by analyzing the user's usage pattern. The maximum response length, when configured, may be stored in memory (e.g., memory 130 in FIG. 1).

According to an embodiment, the maximum response length may be configured for each domain. The domain may include at least one of a user intention corresponding to a user query, a response category, or an application. For example, the domain may include (1) health and fitness, (2) games and entertainment, (3) education and reference materials, (4) weather, (5) news and magazines, (6) business and finance, and (7) productivity. The examples of the domain are merely to help in understanding the disclosure, and are not intended to limit the disclosure. The health and fitness domain may be divided into detailed domains including at least one of time, location, or service. The processor 120 may identify a domain corresponding to a user query, and identify whether a maximum response length configured for the identified domain exists.

According to an embodiment, the maximum response length may be configured to be different for each type of content included in a response. For example, the maximum response length may be “100 bytes.” When the type of content is “text,” the maximum response length may be “500 characters.” When the content type includes “text” and “image,” the text included in the maximum response length may be 300 characters, and the number of images included in the maximum response length may be two or the size of one image may be 3*3 (width*height). When the content type includes “text” and “video,” the text included in the maximum response length may be 150 characters, the size of the video included in the maximum response length may be 5*5 (horizontal*vertical), and the capacity of the video may be 50 bytes. The examples are to help in understanding the disclosure, and the disclosure is not limited by the examples.

The processor 120 may perform operation 405 when the maximum response length exists, and may perform operation 406 when the maximum response length does not exist.

When the maximum response length exists, the processor 120 may transfer the maximum response length and the user query to the artificial intelligence (AI) engine in operation 405. The processor 120 may generate a response corresponding to the user query by using the AI engine. The processor 120 may generate the response based on the maximum response length when generating the response. That is, when the maximum response length is “100 bytes,” the processor 120 may limit the amount of content included in the response to within 100 bytes. The processor 120 may directly generate a response via the AI engine, or transmit the user query and the maximum response length to an intelligent server (e.g., server 108 in FIG. 1 or generative artificial intelligence system in FIG. 2) via a communication module (e.g., communication module 190 in FIG. 1) and receive a response from the server 108. Alternatively, the processor 120 may receive the entire response from the server 108, and then summarize the response to match the maximum response length or may display only a portion of the response, which corresponds to the maximum response length.

When the maximum response length does not exist, the processor 120 may transfer only the user query to the AI engine in operation 406. The processor 120 may generate a response corresponding to the user query by using the AI engine. In this instance, the volume of the generated response may have no limit. The processor 120 may transmit the user query to the server 108 via the communication module 190 and receive a response from the server 108.

In operation 407, according to an embodiment, the processor 120 may provide (display or output) the response obtained from the AI engine. The processor 120 may provide a response generated based on the maximum response length. Alternatively, the processor 120 may provide a response generated irrespective of the maximum response length. When providing the response, the size of a window for providing the response may be variably changed (e.g., increased (or expanded, extended) or reduced) based on the size (or length, amount) of the first response. The response may be output via a speaker (e.g., sound output module 155 in FIG. 1) by using a TTS function, or may be displayed on the display module 160. For example, when the user query is a voice command, the processor 120 may output the response as audio via the sound output module 155. When the user query is input (e.g., text input) via a writing input via a pen or a keypad, the processor 120 may display the response on the display module 160. The response may include at least one of text, an image, audio, or video.

According to an embodiment, the processor 120 may generate a first response based on a maximum response length, and generate a second response irrespective of the maximum response length. The processor 120 may provide the first response, and when a detailed view of the first response is requested by the user, the processor 120 may provide the second response. Alternatively, the processor 120 may generate a response based on the user query, summarize the response to correspond to the maximum response length, and provide the summarized response. Alternatively, the processor 120 may generate a response based on the user query and may provide an upper portion of the generated response, which corresponds to the maximum response length. Alternatively, the processor 120 may request, from the server 108, response generation irrespective of the maximum response length, summarize the response received from the server 108 to match the maximum response length, and provide the response. Alternatively, the processor 120 may provide an upper portion of the received response, which corresponds to the maximum response length.

According to an embodiment, when providing the response, the processor 120 may display a response stop object if content to be provided remains although not displayed on the display module 160. The response stop object may be to request to stop the response. When the response stop object is selected, the processor 120 may stop generating a response or stop receiving a response from the server 108.

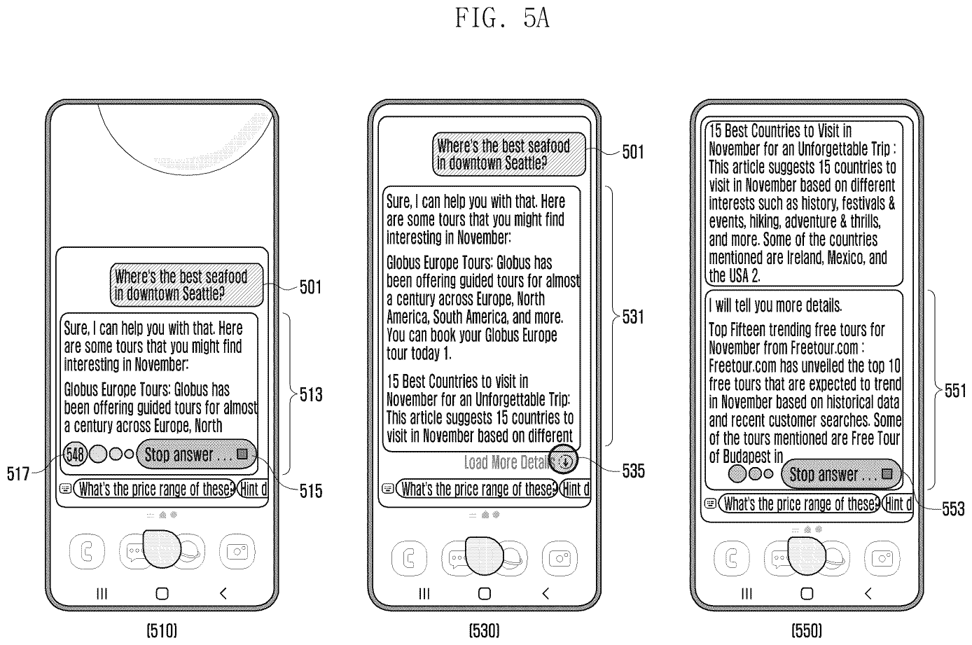

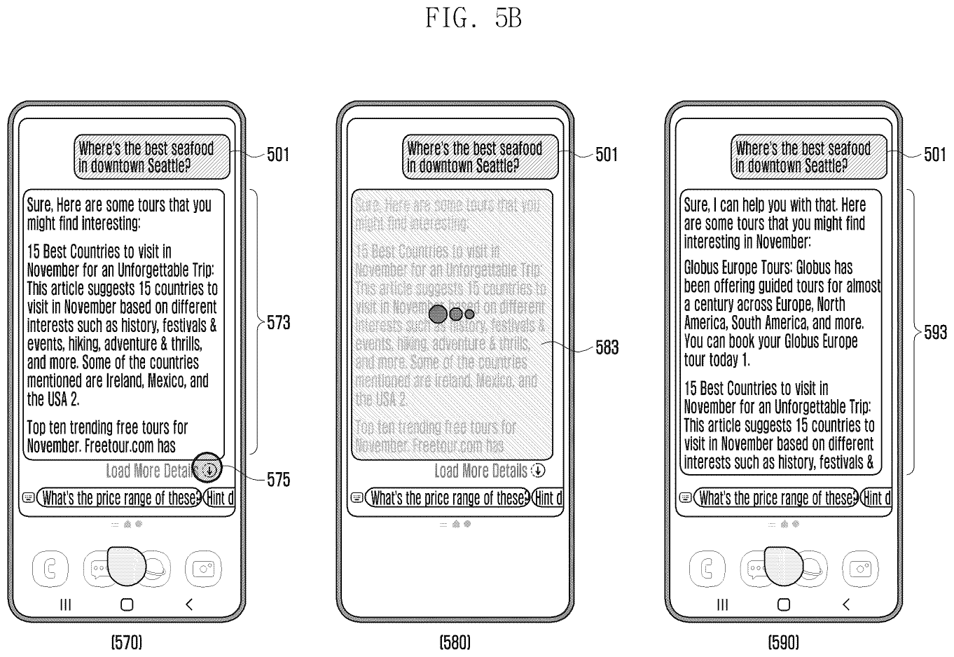

FIG. 5A is a diagram illustrating an example of generating a response based on a maximum response length in an electronic device according to an embodiment of the disclosure.

Referring to FIG. 5A, a processor (e.g., processor 120 in FIG. 1) of an electronic device (e.g., electronic device 101 in FIG. 1) according to an embodiment may receive a user query 501 via an assistant application and display a first user interface 510 on a display (e.g., display module 160 in FIG. 1). The assistant application may include a voice assistant and an AI assistant. Although it is written as a “voice assistant,” various other inputs (e.g., text input via a keypad, writing input via a pen, and gesture input) are allowed in addition to voice. The first user interface 510 may include a first response 513 corresponding to the user query 501, a maximum response length 517, and a response stop object 515. The user query 501 may be a voice command (e.g., user utterance) obtained via a microphone, or may be text obtained via a writing input via a pen or a keypad displayed on an execution screen of the executed assistant application. When a voice command is received as the user query 501, the processor 120 may convert the voice command to text and display the text associated with the user query 501.

The processor 120 may generate a response based on the user query 501. When generating a response, the processor 120 may determine whether a maximum response length exists, and when the maximum response length exists, may generate a response based on the maximum response length using an artificial intelligence (AI) engine. Alternatively, when the maximum response length exists, the processor 120 may transmit the user query 501 and the maximum response length to an intelligent server (e.g., server 108 in FIG. 1 or generative artificial intelligence system in FIG. 2) via a communication module (e.g., communication module 190 in FIG. 1), and receive a response from the server 108. The generated response may be generated based on the maximum response length. The processor 120 may output the first response 513 via a speaker (e.g., sound output module 155 in FIG. 1) or may display the first response 513 on the display module 160. The first response 513 may include at least one of text, an image, audio, or video.

When providing the first response 513, the size of a window (or area or bubble) for providing (or displaying) the first response 513 may be variably changed (e.g., increased (or expanded, extended) or reduced) based on the size (or length or amount) of the first response. The processor 120 may increase the window size of the first response 513 while reducing a number for the maximum response length 517. When the maximum response length 517 is configured, the number of characters of the maximum response length 517 may be counted and displayed such that a user may recognize the current status of the number of loaded characters among all the characters. The processor 120 may display a response stop object 515, if there is more content to be provided as a response to the user query 501, in addition to the first response 513. When the response stop object 515 is selected, the processor 120 may stop generating a response or stop receiving a response from the server 108. The processor 120 may display the response stop object 515 so as to stop providing a response upon the user's request while providing the first response 513, thereby improving user convenience.

While providing the first user interface 510, when the window size of the first response 513 is increased, a second user interface 530 may be provided (or displayed). The second user interface 530 may include a second response 531 corresponding to the user query 501 and a detail view object 535. The first response 513 is a state in which only a portion of a response to a user query is displayed, and the second response 531 may be a state in which a subsequent response to the first response 513 is sequentially displayed and the volume of the response increases. The response may be received all at once from the server 108 or may be received sequentially from the beginning of the response. The first response 513 and the second response 531 are distinguished as “first” and “second” for the purpose of understanding the disclosure since the lengths of the responses are different, and the disclosure is not limited thereto. When the second response 531 is generated based on the maximum response length and there is no content to be provided based on the user query 501, other than the second response 531, the processor 120 may display the detail view object 535. The second response 531 may be a response generated based on the user query 501 and the maximum response length 517. The first response 513 may be a portion of the second response 531.

When the detail view object 535 is selected in the second user interface 530, the processor 120 may provide a third user interface 550. The processor 120 may determine that the detailed view object 535 is selected when a user touches the detailed view object 535 or inputs a user utterance such as “tell me more,” “detail,” or “in detail.” The third user interface 550 may include a third response 551 and a response stop object 553. In response to the user query 501, the processor 120 may generate the third response 551 irrespective of the maximum response length. The processor 120 may request, from the server 108, a response to the user query 501, and may receive the third response 551 from the server 108. The third response 551 may be generated regardless of the maximum response length. When content to be provided based on the user query 501 remains in addition to the third response 551, the processor 120 may display a response stop object 553.

FIG. 5B is a diagram illustrating an example of providing a detailed view of a response in an electronic device according to an embodiment of the disclosure.

Referring to FIG. 5B, the processor 120 may display a fourth user interface 570 including a fourth response 573 to the user query 501 on the display module 160. The fourth response 573 may be a response generated based on the maximum response length. When the fourth response 573 is generated based on the maximum response length and there is no content to be provided based on the user query 501, other than the fourth response 573, the processor 120 may display a detail view object 575. The detailed view object 575 may be for requesting a response to the user query 501 regardless of the maximum response length. The processor 120 may display the detail view object 575 to provide a response irrespective of the maximum response length upon the user's request, even if the processor 120 provides a response based on the maximum response length, thereby improving user convenience.

When the detail view object 575 is selected in the fourth user interface 570, the processor 120 may provide a fifth user interface 580. The fifth user interface 580 may include a screen 583 indicating that a response to the user query 501 is being generated (or updated). The processor 120 may generate the response to the user query 501 regardless of the maximum response length. The processor 120 may display the fifth user interface 580 on the display module 160 while generating (or updating) the response to the user query 501 regardless of the maximum response length. When the response to the user query 501 is generated, the processor 120 may provide a sixth user interface 590. The sixth user interface 590 may include a user query 501 and a fifth response 593 to the user query 501. The fifth response 593 may be a response generated based on the user query 501 regardless of the maximum response length.

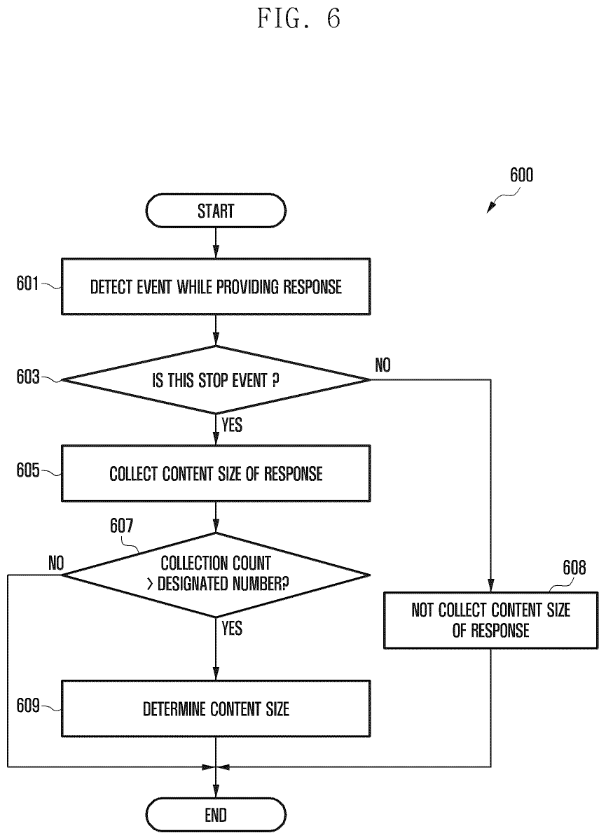

FIG. 6 is a flowchart 600 illustrating a method of collecting a length of a response in an electronic device according to an embodiment of the disclosure.

In the following embodiments, operations may be performed in sequence, but are not necessarily performed in sequence. For example, the order of the operations may be changed, and at least two operations may be performed in parallel.

Referring to FIG. 6, in operation 601, a processor (e.g., processor 120 of FIG. 1) of an electronic device (e.g., electronic device 101 of FIG. 1) according to an embodiment may detect an event, while providing a response. The event may include a user input. The user input may include text input via a voice command, button selection, or a writing input via a pen or a keypad. When providing a response to a user query, the size of a window for providing the response may be variably changed (e.g., increased (or expanded, extended) or reduced) based on the size (or length, amount) of a first response, and the response may be displayed on a display (e.g., display module 160 in FIG. 1). If content to be displayed remains, other than the response displayed on the display module 160, the processor 120 may display an object (e.g., indicator, software button) for stopping displaying of the response. The user may select the response stop object, press a home key, press a lock key (or power key), or terminate (or cancel) the execution of the assistant application.

The assistant application may include a voice assistant and an AI assistant. Although it is written as a “voice assistant,” various other inputs (e.g., text input via a keypad, writing input via a pen, and gesture input) are allowed in addition to voice.

In operation 603, according to an embodiment, the processor 120 may determine whether the detected event is a response stop event. For example, when the response stop object displayed on the display module 160 is touched, or a voice command such as “stop responding,” “enough,” or “okay” which is the same as selecting the response stop object is input, the processor 120 may determine that the stop of responding is requested. According to an embodiment, when a user input for not displaying an execution screen of the assistant application on the display module 160 is detected, the processor 120 may determine the same as a response stop event. Although it is written as a “voice assistant,” various other inputs (e.g., text input via a keypad, writing input via a pen, and gesture input) are allowed in addition to voice. For example, the response stop event may include a user input associated with switching an execution screen of the assistant application to a home screen (e.g., selecting a home key), turning off the display module 160 (or power saving mode) (e.g., selecting a power key or a lock key), or terminating (or canceling) the execution of the assistant application.

When the detected event is a response stop event, the processor 120 may perform operation 605, and when the detected event is not a response stop event, the processor 120 may perform operation 608.

When the detected event is a response stop event, the processor 120 may collect the length of the response in operation 605. The length (or size, amount) of the response may indicate to what extent the content is included in the response displayed on the display module 160. The response may include at least one of text, an image, audio, or video. The processor 120 may collect the length of the response for the same domain as the user query.

According to an embodiment, the processor 120 may not collect the length of the response when a user input (e.g., utterance or text input) for correcting or canceling the stop of responding is received immediately after the response stop event.

According to an embodiment, the processor 120 may configure a maximum response length for each domain. Alternatively, the processor 120 may configure a maximum response length for each of the time information or location information. When collecting the length of the response, the processor 120 may collect at least one of the domain corresponding to the user query, time information, or location information together.

According to an embodiment, the response may be displayed on the display module 160 and/or output as audio to a speaker (e.g., sound output module 155 in FIG. 1). When the response is output to the sound output module 155, the length of the response displayed on the display module 160 may be different from the length of the response output to the sound output module 155. When the length of the response displayed on the display module 160 and the length of the response output to the sound output module 155 are different, the processor 120 may collect the length of the response displayed on the display module 160. Alternatively, when the length of the response displayed on the display module 160 and the length of the response output to the sound output module 155 are different, the processor 120 may collect the length of the response output to the sound output module 155, according to a configuration of the electronic device 101 or a configuration by the user.

In operation 607, according to an embodiment, the processor 120 may determine whether the number of times of collecting the length of the response exceeds a designated number. The designated number may be a threshold (e.g., 10, 20, 30) serving as a criterion for configuring (or determining) a maximum response length. The processor 120 may determine whether the response collection count for the same domain as the user query exceeds a designated number. Alternatively, the processor 120 may determine whether the response collection count in association with time information indicating when the user query is received exceeds a designated number. Alternatively, the processor 120 may determine whether the response collection count in association with the location information indicating where the user query is received exceeds a designated number.

When the response collection count exceeds the designated number, the processor 120 may perform operation 609, and when the response collection count does not exceed the designated number, the process may be terminated.

When the response collection count exceeds the designated number, the processor 120 may determine a maximum response length in operation 609. The maximum response length may be to limit the amount of content to be included in a response to a user query. When the user requests to stop displaying (e.g., selecting a response stop object) while a response is being displayed on a screen, the processor 120 may determine a maximum response length based on the length (e.g., number of characters) of the response displayed on the screen. When the total length of the response is 300 characters, and the user presses the response stop object in the state in which 100 characters are displayed on the screen, 100 characters may be recognized as the number of characters preferred by the user. The processor 120 may analyze the user's usage pattern based on the collected response length and determine, based on the analysis result, a maximum response length. The processor 120 may learn (e.g., machine learning) the user's usage pattern based on the collected response length, and determine, based on the learning result, a maximum response length. When the maximum response length is determined, the processor 120 may store the maximum response length in the memory (e.g., memory 130 in FIG. 1). The processor 120 may configure a maximum response length for each of the domain, time information, and location information.

If the detected event is not a response stop event, the processor 120 may not collect the length of the response in operation 608. For example, when the detected event is a subsequent user query (or a new user query), the processor 120 may not collect the length of the response.

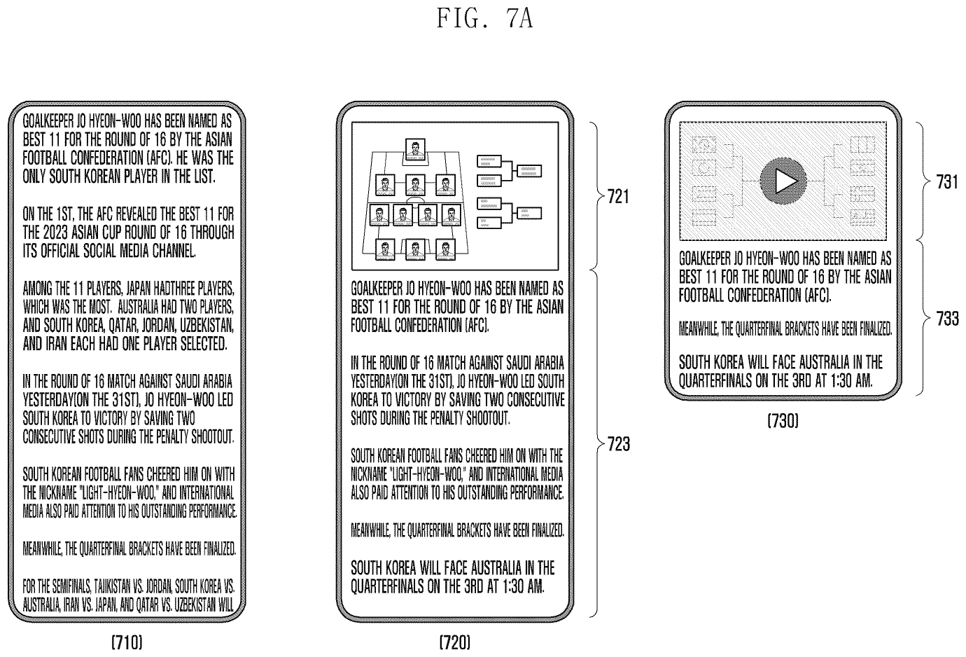

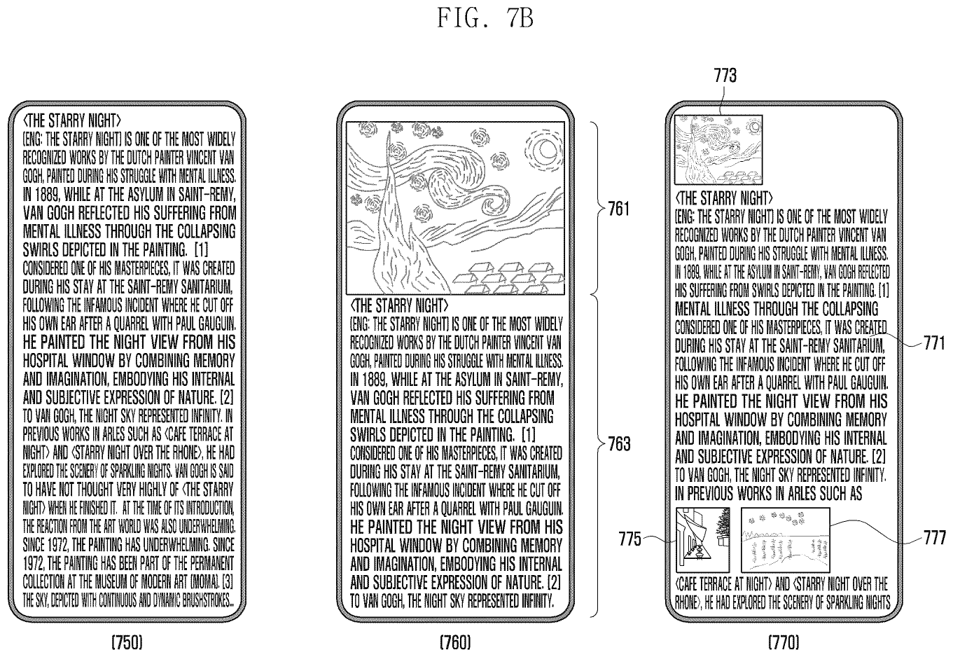

FIGS. 7A and 7B are diagrams illustrating an example of determining a maximum response length based on a type of content in an electronic device according to various embodiments of the disclosure.

Referring to FIG. 7A, a processor (e.g., processor 120 in FIG. 1) of an electronic device (e.g., electronic device 101 in FIG. 1) according to an embodiment may adjust a preferred amount of information by applying an information weight for each content type. For example, when only text is included in a response and when text and an image are included in a response, a maximum response length of the text may be adjusted. The processor 120 may configure a maximum response length to “500 characters” for text. First diagram 710 shows a response generated by including text of 500 characters, which is the maximum response length, when the response is composed of only text. Second diagram 720 shows a response generated by including text 723 of 300 characters based on the maximum response length, and including an image 721 corresponding to the remaining text of 200 characters. A maximum response length of an image may include the size of the image or the number of images. Third diagram 730 shows a response generated by including text 733 of 150 characters, which is the maximum response length, and a video 731 corresponding to the remaining text of 350 characters. A maximum response length of video may be configured as a video display size or a video capacity. The numerical examples are for the purpose of helping in understanding the disclosure and do not limit the disclosure.

Referring to FIG. 7B, the processor 120 may apply a weight differently depending on the size of an image or video, and may adjust the amount of information to transfer differently based on an image size even though the same image is used. The processor 120 may configure the maximum response length to 700 characters based on a user query of “What was the picture of Picasso's starry night?.” The processor 120 may provide a first response 750, a second response 760, or a third response 770 according to a content type. The first response 750 may be an example of a response generated by including text of 700 characters which is the maximum response length when only text is included. The second response 760 may be an example of a response generated by including text 763 of 350 characters based on the maximum response length, and including an image 761 having a size corresponding to the remaining text of 350 characters. The third response 770 may be an example of a response generated by including include text 771 of 450 characters based on the maximum response length, and including three images, each having a size corresponding to about 80 characters, to fill the rest. Each of a first image 773, a second image 775, and a third image 777 may be have a size corresponding to text of about 80 characters. The numerical examples are for the purpose of aiding in the understanding of the disclosure and do not limit the disclosure.

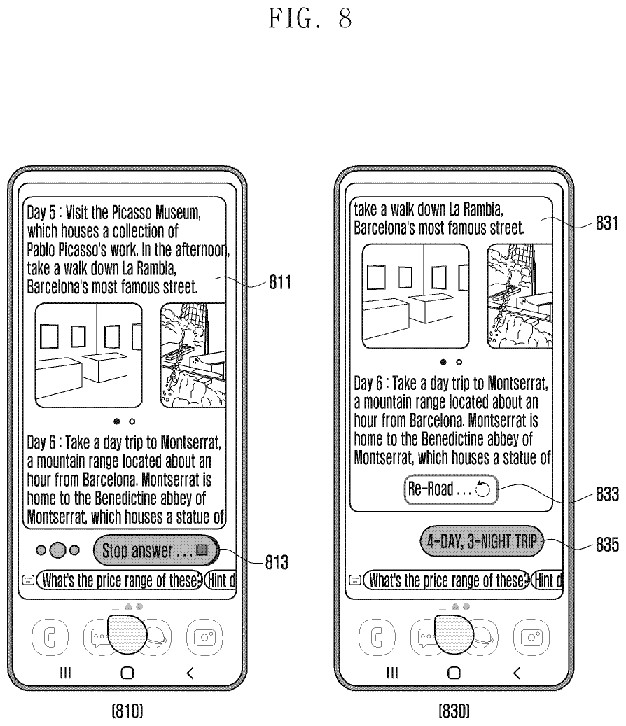

FIG. 8 is a diagram illustrating an example of collecting a length of a response in an electronic device according to an embodiment of the disclosure.

Referring to FIG. 8, a processor (e.g., processor 120 of FIG. 1) of an electronic device (e.g., electronic device 101 of FIG. 1) according to an embodiment may display a first user interface 810 including a first response 811 and a response stop object 813 on a display (e.g., display module 160 of FIG. 1). When providing the first response 811, the size of a window for providing the first response 811 may be variably changed (e.g., increased (or expanded, extended) or reduced) based on the size (or length, amount) of the first response. The processor 120 may provide the response stop object 813 when a response to be displayed in addition to the first response 811 exists. The processor 120 may detect a user input while providing the first response 811. When the response stop object 813 is selected, the processor 120 may stop providing the first response 811.

The processor 120 may receive a user input after the response stop object 813 is selected. The processor 120 may analyze the user input and display a second user interface 830 on the display module 160. The user input may include a voice command (or user utterance, user query). The second user interface 830 may include a second response 831, a response reload object 833, and a user query 835. The second response 831 may be the same as the first response 811. The response reload object 833 may be for requesting to continue displaying (or providing) a response after the second response 831. The user query 835 may be the user input expressed in text.

The processor 120 may not collect the length of the second response 831 when the user input detected after the response stop object 813 is selected is the user query 835. The user query 835 may not be a query to add information to the second response 831 to search, or to cancel the result itself. That is, the user query 835 is not feedback for a response length for configuring a maximum response length, and thus the processor 120 may not collect the length of the second response 831.

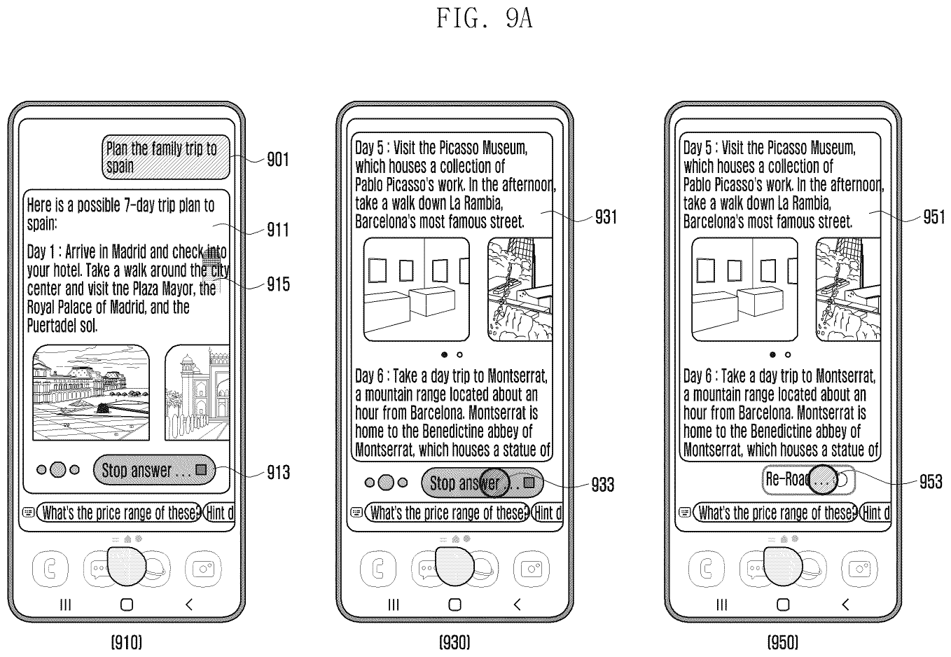

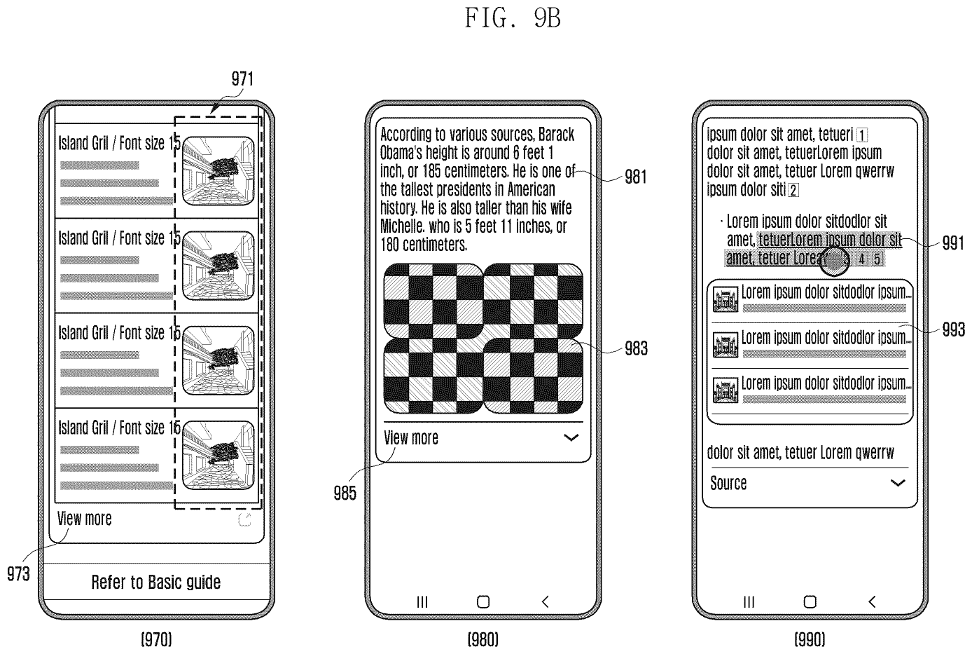

FIGS. 9A and 9B are diagrams illustrating an example of providing a detailed response in response to a user request in an electronic device according to various embodiments of the disclosure.

Referring to FIG. 9A, a processor (e.g., processor 120 in FIG. 1) of an electronic device (e.g., electronic device 101 in FIG. 1) according to an embodiment may display a first user interface 910 including a user query 901, a first response 911, and a response stop object 913 on a display (e.g., display module 160 in FIG. 1). The processor 120 may generate a first response 911 based on a user query 901. When generating the first response 911, the processor 120 may determine whether a maximum response length exists, and if the maximum response length exists, generate, based on the maximum response length, the first response 911 by using an artificial intelligence (AI) engine. The processor 120 may output the first response 911 via a speaker (e.g., sound output module 155 in FIG. 1) or may display the first response 911 on the display module 160. The first response 911 may include at least one of text, an image, audio, or video.

When providing the first response 911, the size of a window (or area or bubble) for providing (or displaying) the first response 911 may be variably changed (e.g., increased (or expanded, extended) or reduced) based on the size (or length or amount) of the first response. The processor 120 may detect a user input 915 of scrolling while displaying the first user interface 910. The processor 120 may display the first response 911 fast according to a scrolling speed of the user input 915. According to the scrolling speed of the user input 915, the processor 120 may provide the first response 911 at a speed faster than the speed of streaming the first response 911. When scrolling is rapidly performed, the processor 120 may rapidly increase a window of the first response 911 by a scrolled area so as to continuously display the content of the first response 911.

If a user feels that a response is too long while navigating the content via scrolling, the user may select (e.g., touch) the response stop object 913. Alternatively, the user may provide a user utterance (e.g., voice command) such as “stop responding,” “enough,” or “okay.” A second user interface 930 may be an example in which a response stop object 933 is selected while a second response 931 is provided. The first response 911 is a state in which only a portion of a response to a user query is displayed, and the second response 931 may be a state in which a subsequent response to the first response 911 is sequentially displayed and the volume of the response increases. The response may be received all at once from the server 108 or may be received sequentially from the beginning of the response. Text included in the second response 931 is sequentially added and uploaded in the vertical (or longitudinal) direction, and an image may be displayed in the horizontal (or lateral) direction. When a user swipes left or right on the image, a new image may be displayed.

When the response stop object 933 is touched or a user utterance equivalent to selection of the response stop object 933 is input, the processor 120 may stop providing the second response 931. The processor 120 may collect, based on the user query 901, the length of the second response 931. For example, the processor 120 may collect the length of the second response 931 for a domain corresponding to the user query 901. Alternatively, the processor 120 may collect the length of the second response 931 in association with time information or location information at the time of receiving the user query 901 or at the time of providing the second response 931.

When the response stop object 933 is selected, the processor 120 may display a third user interface 950 on the display module 160. The third user interface 950 may include a third response 951 and a response reload object 953. The third response 951 may be the same as the second response 931. The response reload object 953 may be for requesting to continue displaying (or providing) a response after the third response 951. When the response reload object 953 is selected, the processor 120 may further provide a response after the third response 951. The response may be sequentially and continuously displayed after the second response 931 and the volume of the response may increase. The response may be received all at once from the server 108 or may be received sequentially from the beginning of the response. By scrolling the second response 931, the processor 120 may display the response that continues below the second response 931.

Referring to FIG. 9B, a response to a user query via an assistant application may include text, an image, or video. The assistant application may include a voice assistant and an AI assistant. Although it is written as a “voice assistant,” various other inputs (e.g., text input via a keypad, writing input via a pen, and gesture input) are allowed in addition to voice. In order to minimize the inconvenience of user input (e.g., scrolling) for identifying a response, the processor 120 may arrange an image included in the response in the horizontal direction so as not to make the length of the response longer in the vertical direction. A fourth user interface 970 shows an example in which an area 971 of the image included in a response is arranged in the vertical direction. The processor 120 may expose only a maximum of N images in the response, and may provide a view more object 973 (e.g., view more). When the view more object 973 is selected in the fourth user interface 970, the processor 120 may additionally provide an image included in the response. A fifth user interface 980 shows an example including text 981 and an image 983 as a response. When the view more object 985 is selected in the fifth user interface 980, the processor 120 may additionally provide an image included in the response. A sixth user interface 990 shows an example in which URL information 991 is provided as a response, and detailed information 993 including multiple images is provided when the URL information 991 is selected.

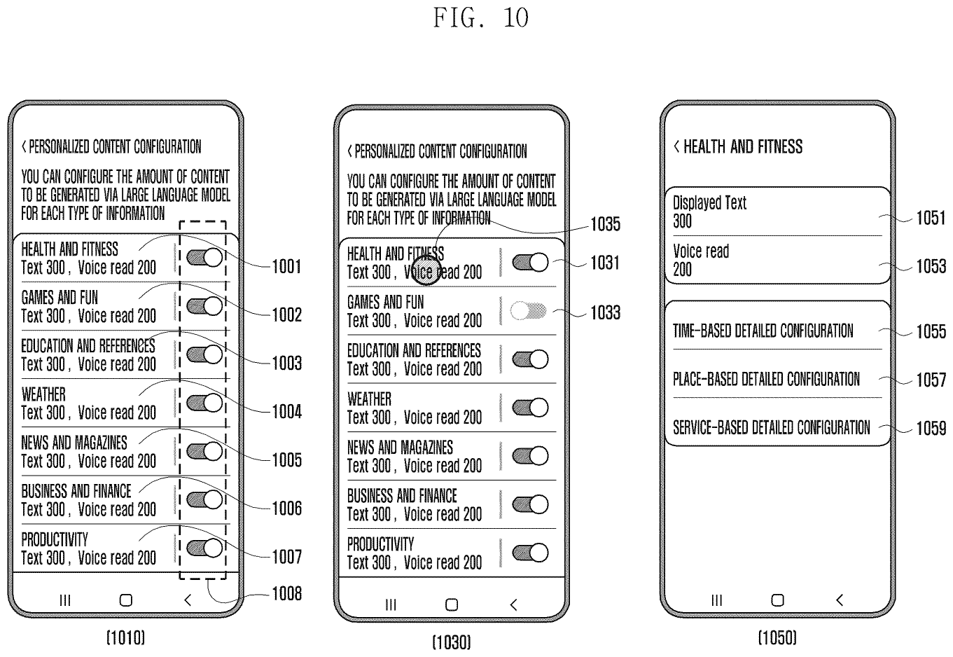

FIG. 10 is a diagram illustrating an example of configuring a maximum response length according to a domain in an electronic device according to an embodiment of the disclosure.

Referring to FIG. 10, in an embodiment, a processor (e.g., processor 120 in FIG. 1) of an electronic device (e.g., electronic device 101 in FIG. 1) may display a first user interface 1010 for configuring a maximum response length according to a domain on a display (e.g., display module 160 in FIG. 1). The user concentration and an expected amount of information may differ according to a domain and content type. Therefore, the processor 120 may provide a user interface that allows a user to directly configure a maximum response length according to a domain, thereby improving user convenience.

A first user interface 1010 may include a toggle button 1008 (e.g., on/off object) for configuring or releasing a maximum response length for each domain. The first user interface 1010 may include toggle buttons 1008 corresponding to a first domain 1001, a second domain 1002, a third domain 1003, a fourth domain 1004, a fifth domain 1005, a sixth domain 1006, and a seventh domain 1007, respectively. The domain may include at least one of a user intention corresponding to a user query, a response category, or an application. The number of domains may be greater than those shown. A second user interface 1030 shows an example in which a maximum response length is configured 1031 with respect to health and fitness (e.g., first domain 1001), and a maximum response length is released 1033 with respect to games and fun (e.g., second domain 1002).

When a user input 1035 for selecting the first domain 1001 is detected in the second user interface 1030, the processor 120 may display a third user interface 1050 on the display module 160. The third user interface 1050 may be for detailed configuration of the maximum response length regarding health and fitness. The maximum response length may be configured differently for displayed text and voice read. For example, a maximum response length 1051 for displayed text may be 300 characters, and a maximum response length 1053 for voice read may be 200 characters. The maximum response length may be configured in detail for each of time, location, and service. The user may select a time-based configuration 1055 to configure a maximum response length of a response provided according to time. Alternatively, the user may select a place (or location)-based configuration 1057 to configure a maximum response length of a response provided according to a place. The user may select a service-based configuration 1059 to configure a maximum response length of a response provided according to a service. Here, the service may include a specific function of an application.

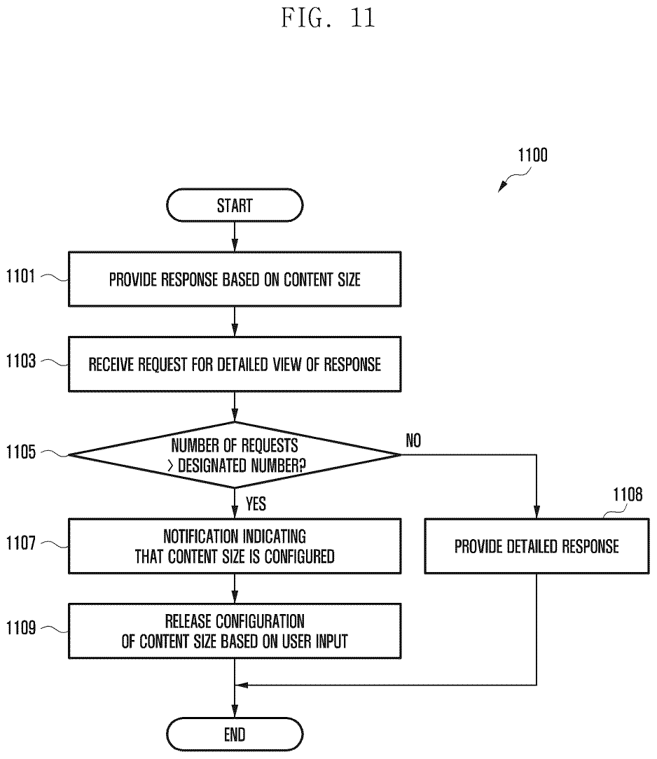

FIG. 11 is a flowchart 1100 illustrating a method of configuring a maximum response length in an electronic device according to an embodiment of the disclosure.

In the following embodiments, operations may be performed in sequence, but are not necessarily performed in sequence. For example, the order of the operations may be changed, and at least two operations may be performed in parallel.

Referring to FIG. 11, in operation 1101, a processor (e.g., processor 120 of FIG. 1) of an electronic device (e.g., electronic device 101 of FIG. 1) according to an embodiment may provide a response, based on a maximum response length. The processor 120 may generate and provide a response, based on the maximum response length, by using the AI engine. That is, when the maximum response length is “100 bytes,” the processor 120 may limit the amount of content included in the response to within 100 bytes. The processor 120 may directly generate a response via the AI engine, or transmit a user query and the maximum response length to an intelligent server (e.g., server 108 in FIG. 1 or generative artificial intelligence system in FIG. 2) via a communication module (e.g., communication module 190 in FIG. 1) and receive a response from the server 108.

According to an embodiment, the processor 120 may generate a first response based on the maximum response length, and generate a second response irrespective of the maximum response length. The processor 120 may provide the first response, and when a detailed view of the first response is requested by the user, the processor 120 may provide the second response. Alternatively, the processor 120 may generate a response based on the user query, summarize the response to correspond to the maximum response length, and provide the summarized response. Alternatively, the processor 120 may generate a response based on the user query and may provide an upper portion of the generated response that corresponds to the maximum response length. Alternatively, the processor 120 may request, from the server 108, response generation irrespective of the maximum response length, summarize the response received from the server 108 to match the maximum response length, and provide the response. Alternatively, the processor 120 may provide an upper portion of the received response, which corresponds to the maximum response length.

According to an embodiment, the processor 120 may display a response stop object when content to be provided remains, which is not displayed on a display (e.g., display module 160). The response stop object may be to request to stop the response. When the response stop object is selected, the processor 120 may stop generating a response or stop receiving a response from the server 108. Alternatively, after providing the whole generated response, the processor 120 may display a detail view object. The detailed view object may be for requesting a response to a user query regardless of the maximum response length.

In operation 1103, according to an embodiment, the processor 120 may receive a request for a detail view of the response. The processor 120 may determine that the request for a detailed view of the response is received from a user when the detailed view object displayed on the display module 160 is touched or a user utterance such as “tell me more,” “detail,” or “in detail” is input, while providing the response.

In operation 1105, according to an embodiment, the processor 120 may determine whether the number of detailed view requests that are requested exceeds a designated number. The designated number may be a threshold (e.g., 10, 20, 30) serving as a criterion for releasing the maximum response length. The processor 120 may determine whether the number of requests made in association with a domain associated with the user query exceeds a designated number. Alternatively, the processor 120 may determine whether the number of requests made in association with time information at which the user query is received exceeds a designated number. Alternatively, the processor 120 may determine whether the number of requests made in association with location information where the user query is received exceeds a designated number.

When the number of requests exceeds the designated number, the processor 120 may perform operation 1107, and when the number of requests does not exceed the designated number, the processor 120 may perform operation 1108.

When the number of requests does not exceed the designated number, the processor 120 may provide a detailed response regardless of the maximum response length in operation 1108. The processor 120 may provide a response, which is irrelevant to the maximum response length and generated together when generating the response, as the detailed response. Alternatively, when the provided response in operation 1101 is a response summarized to correspond to the maximum response length, the processor 120 may provide an original response. Alternatively, the processor 120 may request, from the server 108, response generation regardless of the maximum response length, and may provide a response received from the server 108.

When the number of requests exceeds the designated number, the processor 120 may provide a notification indicating that a maximum response length is configured in operation 1107. Although the maximum response length is configured in consideration that the user does not want a large volume of response, the user's usage pattern may change to a tendency of seeing more detailed response thereafter. The processor 120 may determine that change or release of the maximum response length is required when the number of requests exceeds the designated number. The processor 120 may inform to what extent (e.g., 500 characters) the maximum response length is configured.

In operation 1109, the processor 120 may release, based on the user input, the configuration of the maximum response length. The processor 120 may delete (e.g., delete from memory) the maximum response length configured for a domain associated with the user query, time information, or location information, when the user requests to release the configuration of the maximum response length. According to an embodiment, the processor 120 may retain the maximum response length upon the user's retention request in response to the notification. Alternatively, the processor 120 may provide a user interface for changing the maximum response length upon the user's change request in response to the notification. The user interface may be the same as the user interface illustrated in FIG. 10.

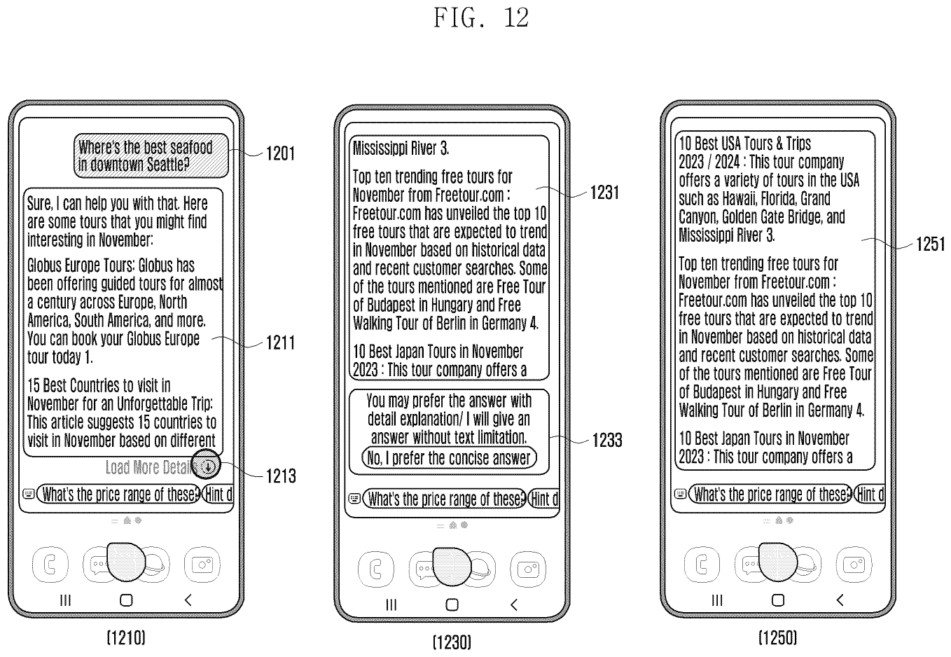

FIG. 12 is a diagram illustrating an example of releasing a maximum response length in an electronic device according to an embodiment of the disclosure.

Referring to FIG. 12, a processor (e.g., processor 120 in FIG. 1) of an electronic device (e.g., electronic device 101 in FIG. 1) according to an embodiment may display a first user interface 1210 including a user query 1201, a first response 1211 to the user query 1201, and a detail view object 1213 on a display (e.g., display module 160 in FIG. 1). When the detail view object 1213 is selected in the first user interface 1210, the processor 120 may determine whether the number of detail view requests that are requested exceeds a designated number. The designated number may be a threshold serving as a criterion for releasing a maximum response length. The processor 120 may determine whether the number of requests made in association with a domain associated with the user query 1201 exceeds a designated number. Alternatively, the processor 120 may determine whether the number of requests made in association with time information at which the user query 1201 is received exceeds a designated number. Alternatively, the processor 120 may determine whether the number of requests made in association with location information at the time when the user query 1201 is received exceeds a designated number.

When the number of requests exceeds the designated number, the processor 120 may display a second user interface 1230 on the display module 160. The second user interface 1230 may include a second response 1231 and a maximum response length change notification 1233. The second response 1231 may be the same as the first response 1211. The maximum response length change notification 1233 may indicate that the maximum response length configuration is changed. Although the processor 120 provides a response according to the maximum response length, a usage pattern may change to a tendency of viewing a more detailed response. When a user agrees to the maximum response length change notification 1233 (YES), the processor 120 may change the maximum response length, and when the user does not agree to the maximum response length change notification 1233 (NO), the processor 120 may retain the maximum response length with the previously configured value. The processor 120 may determine that change or release of the maximum response length is required when the number of requests exceeds the designated number.

When retention of the maximum response length is requested in the second user interface 1230, the processor 120 may display a third user interface 1250 on the display module 160. The third user interface 1250 may include a third response 1251 generated regardless of the maximum response length. The processor 120 may provide a third response 1251 that is unrelated to the maximum response length and generated together when generating the first response 1211. Alternatively, when the first response 1211 is a response summarized to correspond to the maximum response length, the processor 120 may provide an original response as the third response 1251. Alternatively, the processor 120 may request the server 108 to generate a response regardless of the maximum response length, and provide the third response 1251 received from the server 108.

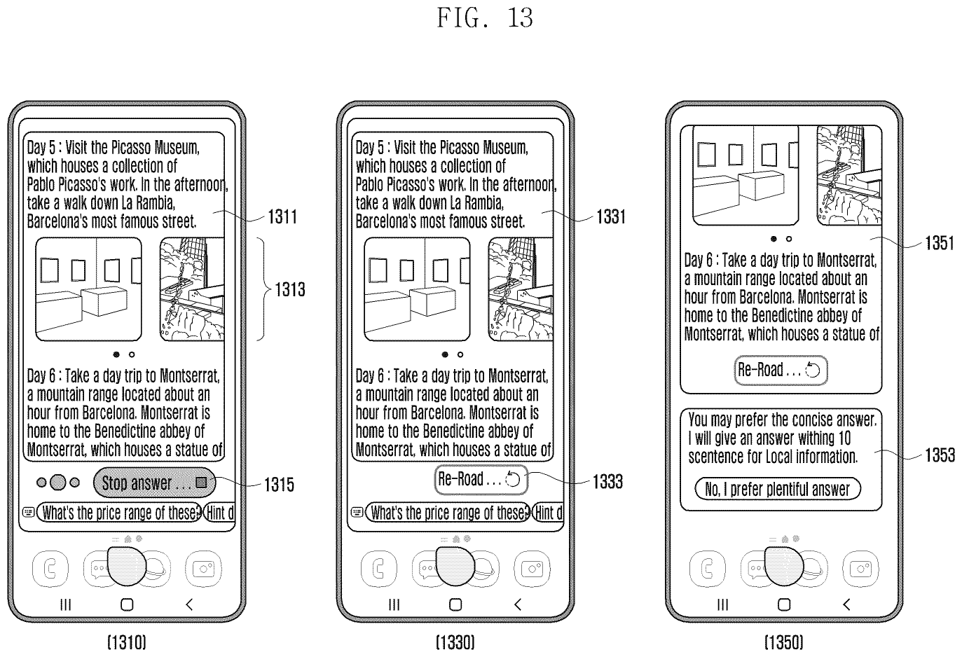

FIG. 13 is a diagram illustrating an example of configuring a maximum response length in an electronic device according to an embodiment of the disclosure.

Referring to FIG. 13, a processor (e.g., processor 120 of FIG. 1) of an electronic device (e.g., electronic device 101 of FIG. 1) according to an embodiment may display a first user interface 1310 including a first response 1311 and a response stop object 1315 on a display (e.g., display module 160 of FIG. 1). The first response 1311 may be such that text is added and uploaded sequentially in the vertical direction (or longitudinal direction), and an image 1313 is displayed in the horizontal direction (or lateral direction). When a user swipes left or right on the image, a new image may be displayed.

When the response stop object 1315 is selected in the first user interface 1310, the processor 120 may display a second user interface 1330 on the display module 160. The second user interface 1330 may include a second response 1331 and a response reload object 1333. The second response 1331 may be the same as the first response 1311. When the response reload object 1333 is selected, the processor 120 may display additional content in addition to the second response 1331.

In addition, the processor 120 may determine whether the number of times of selecting the response stop object 1315 in the first user interface 1310 exceeds a designated number. The designated number may be a threshold serving as a criterion for configuring a maximum response length. The processor 120 may determine whether the number of times of requesting to stop responding in association with a domain associated with a user query exceeds a designated number. The processor 120 may determine whether the number of times of requesting to stop responding in association with time information or location information at the time of receiving the user query, exceeds a designated number.

When the number of times of requesting to stop responding exceeds the designated number, the processor 120 may display a third user interface 1350 on the display module 160. The third user interface 1350 may include a third response 1351 and a notification 1353 of a maximum response length. The third response 1351 may be the same as the second response 1331. The notification 1353 of the maximum response length may indicate to what extent (e.g., 700 characters) the maximum response length is configured. The processor 120 may determine that change or release of the maximum response length is required when the number of times of requesting to stop responding exceeds the designated number. The processor 120 may release the configuration of the maximum response length upon the user's request in response to the notification 1353 of the maximum response length.

An operation method of the electronic device 101 according to an embodiment of the disclosure may include an operation of receiving a user query from a user via an assistant application, an operation of determining whether a maximum response length for limiting the amount of content to be included in a response to the user query exists after receiving the user query, an operation of transferring the maximum response length and the user query to an artificial intelligence (AI) engine when the maximum response length exists, an operation of transferring only the user query to the AI engine when no maximum response length exists, and an operation of providing a response obtained from the AI engine.

The method may further include an operation of detecting a user input requesting a detailed view of the response while displaying the response generated based on the maximum response length and the user query, an operation of requesting, from the AI engine, a response corresponding to the user query irrespective of the maximum response length, based on the user input, and an operation of providing a response obtained from the AI engine.

The method may further include an operation of obtaining, from the AI engine, a first response corresponding to the maximum response length and the user query and a second response corresponding to the user query and irrelevant to the maximum response length, and an operation of providing the first response, and providing the second response in response to a user request.

The method may further include an operation of obtaining, from the AI engine, a response corresponding to the user query irrespective of the maximum response length, an operation of summarizing the obtained response so as to correspond to the maximum response length, and an operation of providing the summarized response.

The method may further include an operation of obtaining, from the AI engine, a response corresponding to the user query irrespective of the maximum response length, and an operation of providing a portion of the obtained response, which corresponds to the maximum response length.

The method may further include an operation of identifying a domain associated with the user query, an operation of identifying a maximum response length configured for the identified domain, and an operation of transferring the maximum response length and the user query to the AI engine.

The method may further include an operation of releasing a configuration of the maximum response length configured for the domain when the number of requests for a detailed view of a response is greater than or equal to a threshold while providing the response corresponding to the domain.

The method may further include an operation of detecting a user input requesting to stop the response while displaying the response in sequence, an operation of collecting, based on the user input, a length of the response displayed on the display, and an operation of not collecting a length of the response when a new user query obtained after requesting to stop the response is not associated with the stop of the response.

The method may further include an operation of determining the maximum response length based on at least one of a domain, time information, or location information, respectively. The electronic device according to various

embodiments disclosed herein may be one of various types of electronic devices. The electronic devices may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities mat be separately disposed in any other element. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and detailed may be made therein without departing from the spirit and scope of the disclosure as defined by the appended claims and their equivalents.

What is claimed is:

1. An electronic device comprising:
a display;
memory, comprising one or more storage media, storing instructions; and
one or more processors communicatively coupled to the display and the memory,
wherein the instructions, when executed by the one or more processors individually or collectively, cause the electronic device to:
receive a user query from a user via an assistant application,
after receiving the user query, determine whether a maximum response length limiting an amount of content to be included in a response to the user query exists,
in case that the maximum response length exists, transfer the maximum response length and the user query to an artificial intelligence (AI) engine,
in case the maximum response length does not exist, transfer only the user query to the AI engine, and
provide a response obtained from the AI engine.

2. The electronic device of claim 1, wherein the instructions, when executed by the one or more processors individually or collectively, further cause the electronic device to:
while displaying the response generated based on the maximum response length and the user query, detect a user input requesting a detailed view of the response,
based on the user input, request a response corresponding to the user query from the AI engine, regardless of the maximum response length, and
provide a response obtained from the AI engine.

3. The electronic device of claim 1, wherein the instructions, when executed by the one or more processors individually or collectively, further cause the electronic device to:
obtain, from the AI engine, a first response corresponding to the maximum response length and the user query, and a second response corresponding to the user query, which is regardless of the maximum response length, and
provide the first response, and provide the second response at a request of the user.

4. The electronic device of claim 1, wherein the instructions, when executed by the one or more processors individually or collectively, further cause the electronic device to:
obtain a response corresponding to the user query from the AI engine, regardless of the maximum response length,
summarize the obtained response such that the response corresponds to the maximum response length, and
provide the summarized response.

5. The electronic device of claim 1, wherein the instructions, when executed by the one or more processors individually or collectively, further cause the electronic device to:
obtain a response corresponding to the user query from the AI engine, regardless of the maximum response length, and
provide a portion of the obtained response, which corresponds to the maximum response length.

6. The electronic device of claim 1, wherein the instructions, when executed by the one or more processors individually or collectively, further cause the electronic device to:
identify a domain associated with the user query,
identify a maximum response length configured for the identified domain, and
transfer the maximum response length and the user query to the AI engine.

7. The electronic device of claim 6, wherein the instructions, when executed by the one or more processors individually or collectively, further cause the electronic device to while providing a response corresponding to the domain, release a configuration of the maximum response length configured for the domain in case that a number of requests for a detailed view of the response is greater than or equal to a threshold.

8. The electronic device of claim 1, wherein the instructions, when executed by the one or more processors individually or collectively, further cause the electronic device to:
while successively displaying the response, detect a user input requesting to stop the response, and
based on the user input, collect a length of the response displayed on the display.

9. The electronic device of claim 1, wherein the instructions, when executed by the one or more processors individually or collectively, further cause the electronic device to, in case that a new user query obtained after requesting to stop the response is not associated with the stopping of the response, not collect a length of the response.

10. The electronic device of claim 1, wherein the instructions, when executed by the one or more processors individually or collectively, further cause the electronic device to determine the maximum response length, based on at least one of a domain, time information, or location information.

11. The electronic device of claim 1, wherein the instructions, when executed by the one or more processors individually or collectively, further cause the electronic device to:
successively display a response corresponding to the user query via the assistant application,
while providing the response, detect a user input requesting to stop the response,
based on the user input, collect a length of the response displayed on the display,
determine a maximum response length of a response by learning the collected length; and
store the determined maximum response length in the memory.

12. A method performed by an electronic device, the method comprising:
receiving, by the electronic device, a user query from a user via an assistant application;
after receiving the user query, determining, by the electronic device, whether a maximum response length limiting an amount of content to be included in a response to the user query exists;
in case that the maximum response length exists, transferring, by the electronic device, the maximum response length and the user query to an artificial intelligence (AI) engine;
in case that the maximum response length does not exist, transferring, by the electronic device, only the user query to the AI engine; and
providing, by the electronic device, a response obtained from the AI engine.

13. The method of claim 12, further comprising:
while displaying the response generated based on the maximum response length and the user query, detecting a user input requesting a detailed view of the response;
based on the user input, requesting a response corresponding to the user query from the AI engine, regardless of the maximum response length; and
providing a response obtained from the AI engine.

14. The method of claim 12, further comprising:
obtaining, from the AI engine, a first response corresponding to the maximum response length and the user query, and a second response corresponding to the user query, which is regardless of the maximum response length; and
providing the first response, and providing the second response at a request of the user.

15. The method of claim 12, further comprising:
obtaining a response corresponding to the user query from the AI engine, regardless of the maximum response length;
summarizing the obtained response such that the response corresponds to the maximum response length; and
providing the summarized response.

16. The method of claim 12, further comprising:
obtaining a response corresponding to the user query from the AI engine, regardless of the maximum response length; and
providing a portion of the obtained response, which corresponds to the maximum response length.

17. The method of claim 12, further comprising:
identifying a domain associated with the user query;
identifying a maximum response length configured for the identified domain; and
transferring the maximum response length and the user query to the AI engine.

18. The method of claim 17, further comprising:
while providing a response corresponding to the domain, releasing a configuration of the maximum response length configured for the domain in case that a number of requests for a detailed view of the response is greater than or equal to a threshold.

19. One or more non-transitory computer-readable storage media storing one or more computer programs including computer-executable instructions that, when executed by one or more processors of an electronic device individually or collectively, cause the electronic device to perform operations, the operations comprising:
receiving, by the electronic device, a user query from a user via an assistant application;
after receiving the user query, determining, by the electronic device, whether a maximum response length limiting an amount of content to be included in a response to the user query exists;
in case that the maximum response length exists, transferring, by the electronic device, the maximum response length and the user query to an artificial intelligence (AI) engine;
in case that the maximum response length does not exist, transferring, by the electronic device, only the user query to the AI engine; and
providing, by the electronic device, a response obtained from the AI engine.

20. The one or more non-transitory computer-readable storage media of claim 19, the operations further comprising:
while displaying the response generated based on the maximum response length and the user query, detecting a user input requesting a detailed view of the response;
based on the user input, requesting a response corresponding to the user query from the AI engine, regardless of the maximum response length; and
providing a response obtained from the AI engine.
